(19) United States
(12) Patent Application Publication
(10) Pub. No.: US 2011/0205641 A1
(43) Pub. Date: Aug. 25, 2011

(54) Wide Angle Imaging Lens System with Two Positive Lenses

(76) Inventor: Bo-Yuan Shih, Taipei (TW)

(21) Appl. No.: 12/276,321

(22) Filed: Nov. 22, 2008

(30) Foreign Application Priority Data
May 28, 2008 (TW) 097119783

(51) Int. Cl. G02B 13/18

(52) U.S. Cl. 359/717

(57) ABSTRACT

A wide-angle imaging lens system with two positive lenses is revealed. The imaging lens system includes a first lens with positive refractive power that is a biconvex aspherical lens and a second lens having positive refractive power that is a meniscus lens with concave surface facing the image side. In the concave surface of the second lens, the effective diameter range from the lens center to the edge includes at least one inflection point that changes the refractive power of the second lens from positive to negative. Moreover, the following conditions are satisfied by the imaging lens system:

$$2 ω \geq {70}^{°} ; 0.3 \leq \frac{bf}{TL} \leq 0.6$$

wherein bf is back focal length, TL is distance from an aperture stop to an image plane, and 2ω is maximum field angle. Thus, the imaging lens system of the present invention has wide angle effects, short back focal length, and reduced overall length.

### BACKGROUND OF THE INVENTION

The present invention relates to a wide-angle imaging lens system with two positive lenses, especially to an imaging lens system for mobile phones or mini-cameras with image sensors such as CCD (Charge Coupled Device) or CMOS (Complementary Metal Oxide Semiconductor). The imaging lens system is formed by two positive lenses and is with features of wide angle, short overall(total) length and low cost.

The electronics available now become more compact and multifunctional. Most of them such as digital still cameras, PC (personal computer) cameras, network cameras and mobile phones, even personal digital assistants (PDA) are equipped with an image lens system. The imaging lens system not only requires good imaging quality but also needs compact volume (short overall length) and lower cost. Moreover, the imaging lens system with larger field angle can improve image quality of the electronics and match users' requirements.

There are various designs such as two lenses, three lenses, four lenses or five lenses of the imaging lens system applied to mini electronics. Yet while a compromise of resolution and cost, the two lenses is preferred. There are various structures of conventional two lenses imaging lens system and the difference among them or technical character is in the shape of the two lenses, location of the convex surface/concave surface, positive/negative refractive power, or relative optical parameters. Among these designs, the combination of a first lens with positive refractive power and a second lens with positive refractive power can achieve requirement of minimized volume, such as prior arts revealed in US2005/0073753, US2004/0160680, U.S. Pat. No. 7,110,190, U.S. Pat. No. 7,088,528, US2004/0160680, EP1793252, EP1302801, JP2007-156031, JP2006-154517, JP2006-189586, TWM320680, TWI232325, and CN101046544 etc. However, the overall length of these imaging lens systems still requires further improvement. For larger field angle, the imaging lens system in US2008/0030875 includes a lens with positive refractive power and a lens with negative refractive power, the imaging lens system in U.S. Pat. No. 5,835,288 is formed by combinations of biconcave lenses and biconvex lenses, the systems in JP08-334684, JP2005-107368 use combinations of positive/positive refractive power or negative/positive refractive power. Or as shown in JP2004-177976, EP1793252, EP1793254, U.S. Pat. No. 6,876,500, US2004/0160680, U.S. Pat. No. 7,088,528, TWI266074, the combination of the lens with positive refractive power and the lens with positive refractive power. Therefore, the users require the imaging lens system with larger field angle and short overall length. The present invention provides a better design of the imaging lens system applied to electronics such as mini cameras and camera phones.

### SUMMARY OF THE INVENTION

Along an optical axis from the object side to the image side, a wide-angle imaging lens system with two positive lenses according to the present invention consists of an aperture stop, a first lens with positive refractive power that is a biconvex aspherical lens with at least one spherical optical surface, and a second lens having positive refractive power that is a meniscus lens with a convex surface on the object side and a concave surface facing the image side. The convex surface on the object side is a spherical surface or an aspherical surface while the concave surface facing the image side is an aspherical surface. Moreover, on the image side, the effective diameter range from the lens center to the edge includes at least one inflection point that changes the refractive power of the second lens from positive to negative. The imaging lens system satisfies the following conditions:

$$\begin{matrix}2 ω \geq {70}^{°} & ( 1 ) \\ 0.3 \leq \frac{bf}{TL} \leq 0.6 & ( 2 ) \\ \frac{{H}_{+}}{{H}_{t}} \geq 75 \% & ( 3 ) \\ 0.1 \leq \frac{{d}_{2}}{{f}_{s}} \leq 0.3 & ( 4 ) \\ 0.5 \leq \frac{{f}_{2}}{{f}_{1}} \leq 2.2 & ( 5 )\end{matrix}$$

wherein bf is back focal length, TL is distance from the aperture stop to the image plane, 2ω is maximum field angle,
H₊ is perpendicular distance from the inflection point on the image side of the second lens to its intersection point of the optical axis,
Hₜ is perpendicular distance from the maximum optical effective point on the image side of the second lens to the optical axis,
d₂ is distance from the image side of the first lens to the object side of the second lens,
fₛ is effective focal length of the imaging lens system,
f₁ is focal length of the first lens, and
f₂ is focal length of the second lens.

Thereby, the imaging lens system according to the present invention achieves wide angle effects so that the capture angle of mini-cameras or camera phones is increased. Thus the applications of the imaging lens system are increased.

### BRIEF DESCRIPTION OF THE DRAWINGS

FIG. 1 is a schematic drawing showing optical structure of an embodiment according to the present invention;

FIG. 2 is a side view of a second lens of an embodiment according to the present invention;

FIG. 3 is a schematic drawing showing light path of an embodiment according to the present invention;

FIG. 4 shows spherical aberration, field curvature and distortion of an image of an embodiment according to the present invention;

FIG. 5 is a schematic drawing showing light path of another embodiment according to the present invention;

FIG. 6 shows spherical aberration, field curvature and distortion of an image of another embodiment according to the present invention;

FIG. 7 is a schematic drawing showing light path of the third embodiment according to the present invention;

FIG. 8 shows spherical aberration, field curvature and distortion of an image of the third embodiment according to the present invention.

FIG. 9 is a schematic drawing showing light path of the fourth embodiment according to the present invention;

FIG. 10 shows spherical aberration, field curvature and distortion of an image of the fourth embodiment according to the present invention.

FIG. 11 is a schematic drawing showing light path of the fifth embodiment according to the present invention; and;

FIG. 12 shows spherical aberration, field curvature and distortion of an image of the fifth embodiment according to the present invention.

### DETAILED DESCRIPTION OF THE PREFERRED EMBODIMENT

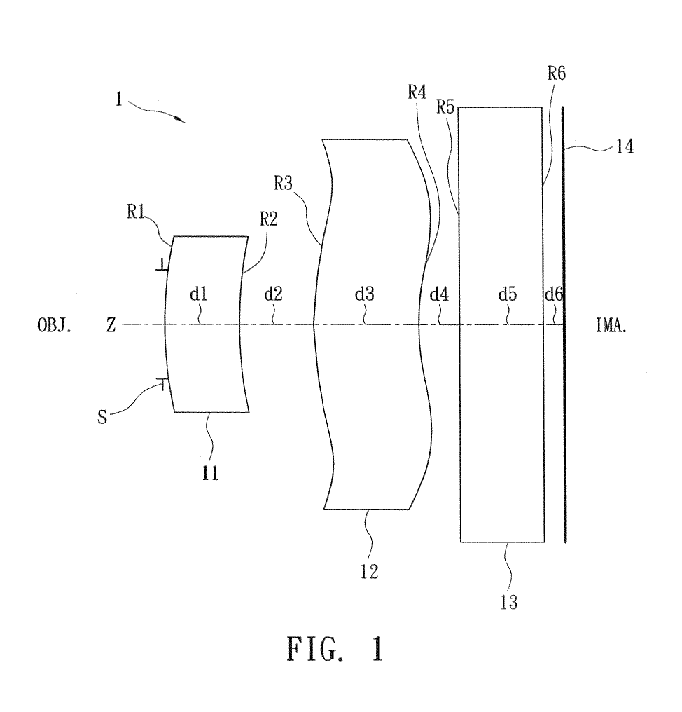

Refer to FIG. 1, along an optical axis Z from the object side to the image side, an imaging lens system 1 according to the present invention consists of an aperture stop S, a first lens 11, a second lens 12, an IR (infrared) cut-off filter 13, and an image sensor 14.

The first lens 11 is a biconcave lens with positive refractive power made from glass or plastic whose refractive index (N_{d}) is larger than 1.5. Moreover, at least one of the object side R1 and the image side R2 of the first lens 11 is an aspherical surface, or both are aspherical surfaces.

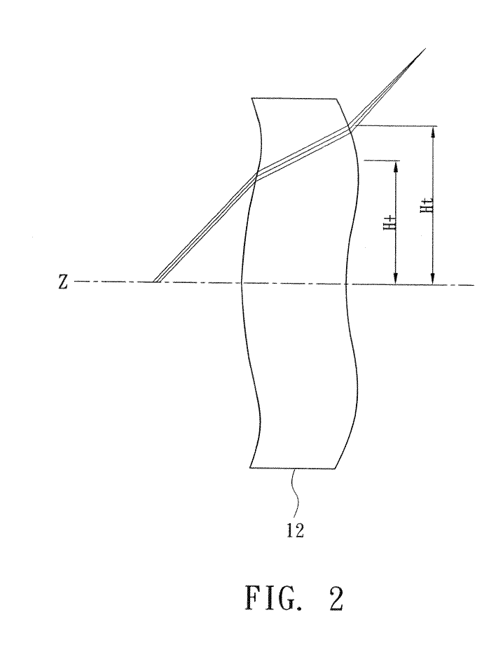

The second lens 12 is a meniscus lens with positive refractive power and the surface on the object side R3 is a convex surface while the surface on the image side R4 is a concave surface. The second lens 12 is made from glass or plastic whose refractive index (N_{d}) is larger than 1.5. The object side surface R3 is a spherical surface or an aspherical surface and the surface on the image side R4 is an aspherical surface. Moreover, the surface on the image side R4 can be a totally concave optical surface or in the effective diameter range from the lens center to the edge, there is at least one inflection point that changes the refractive power of the second lens 12 from positive to negative. The cross section of the lens 12, as shown in FIG. 2, includes a concave center while the two sides are convex and the shape looks like a “M” shape. That means the curvature of a convex surface (or concave surface) of the wavy image side R4 gradually changes from the center area to the peripheral area and turns into a concave surface (or convex surface) so that an inflection point forms. When a tangent line passes the inflection point and intersects with the optical axis, the distance from the inflection point to the optical axis is lens height within positive refractive power range-labeled as H₊. That's the distance (length between) from the inflection point to its intersection point of the optical axis. The distance from the maximum optical effective point of the second lens 12 to the optical axis is labeled as Hₜ. The ratio of H₋ to Hₜ represents the range of change of the refractive power. In order to have better image, the preferred ratio should be larger than 50%. Besides, for wide-angle effect, the preferred ratio is larger than 75%, satisfying the equation (3).

The aperture stop S is a front-positioned aperture that is attached on an object side surface R1 of the first lens 11. The IR cut-off filter 13 is a lens or a film filtering IR light and formed by coating. The image sensor 14 is a CCD or a CMOS.

While capturing images, light from the object passes the first lens 11, the second lens 12, and the IR cut-off filter 13 to form an image on the image sensor 14. Through optical combinations of the radius of curvature of the optical surface and the aspherical surface of the first lens 11 as well as the second lens 12, the lens thickness (d1, d3) and the air gap (d2, d4), the field angle is larger than 70°, satisfying the equation (1). The aspherical Surface Formula is the following equation (6):

$$Z = \frac{{ch}^{2}}{1 + \sqrt{( 1 - ( 1 + K ) {c}^{2} {h}^{2} )}} + {A}_{4} {h}^{4} + {A}_{6} {h}^{6} + {A}_{8} {h}^{8} + {A}_{10} {h}^{10} + {A}_{12} {h}^{12} + {A}_{14} {h}^{14} + {A}_{16} {h}^{16} \qquad ( 6 )$$

wherein c is a radius of curvature,
h represents height of the lens,
K is a conic constant,
A₄˜A₁₆ respectively are 4th, 6th, 8th, 10th, 12th, 14th, and 16th order aspherical coefficient.

According to the above structure, the back focal length of the imaging lens system 1 of the present invention is effectively minimized so that the overall length of the lens system is reduced and is satisfying the equation (2) or equation (4). Furthermore, the aberration is further corrected and the chief ray angle is reduced, the equation (5) is satisfied.

Refer to a list one of each embodiment: the list includes data of optical surface number (#) in order from the object side to the image side, the radius of curvature R (mm) of each optical surface on the optical axis, the on-axis surface spacing d (mm) of each optical surface, the refractive index N_{d} of the lens and the Abbe's number v_{d} of the lens. The optical surface of the lens labeled with * is an aspherical surface. Fno, fs, 2ω respectively represent aperture value (f number), effective focal length and field angle of the imaging lens system 1, respectively.

### The First Embodiment

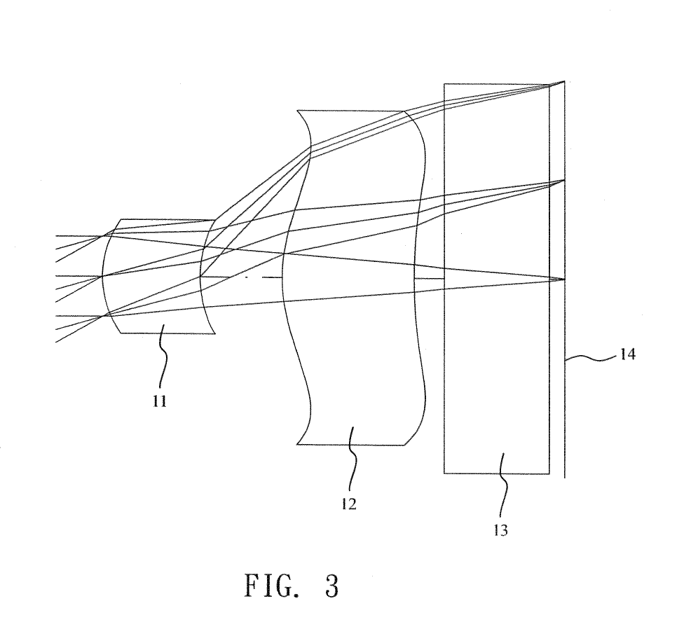

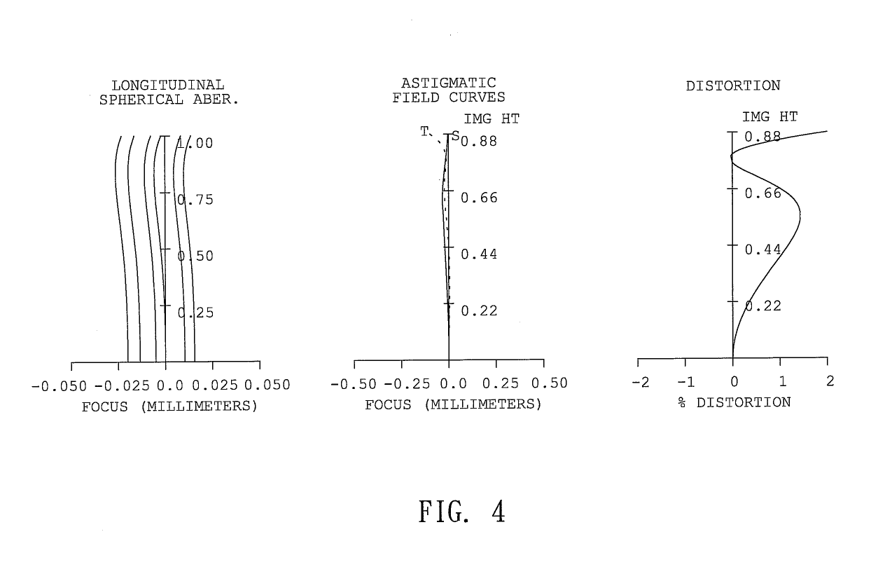

Refer to FIG. 3 & FIG. 4, show the structure and optical path and spherical aberration, field curvature and distortion of this embodiment, respectively.

List 1:
fs = 1.1386 Fno = 3.2 2ω = 76

| Surface | Lens | R | d | Nd | νd |
|---|---|---|---|---|---|
| Object | | ∞ | | | |
| 1 (Stop) | *R1 | 0.5676 | 0.3239 | 1.731 | 40.5 |
| 2 | *R2 | 0.7742 | 0.2687 | | |
| 3 | *R3 | 0.9589 | 0.4346 | 1.566 | 24.7 |
| 4 | *R4 | 3.4119 | 0.1000 | | |
| 5 | R5 | ∞ | 0.3500 | 1.528 | 62.2 |
| 6 | R6 | ∞ | 0.0498 | | |
| Image | | ∞ | | | |

*aspherical surface

List 2:

| | K | A4 | A6 | A8 | A10 | A12 | A14 | A16 |
|---|---|---|---|---|---|---|---|---|
| *R1 | −1.216E+00 | 6.294E−01 | 8.717E+00 | −1.084E+02 | −8.376E+01 | 0.000E+00 | 0.000E+00 | 0.000E+00 |
| *R2 | −1.562E+01 | 3.914E+00 | −1.157E+00 | 2.108E+01 | −5.065E+01 | 0.000E+00 | 0.000E+00 | 0.000E+00 |
| *R3 | −8.724E+00 | 2.002E−02 | −7.834E−01 | 0.000E+00 | 0.000E+00 | 0.000E+00 | 0.000E+00 | 0.000E+00 |
| *R4 | −2.482E+00 | 4.515E−01 | −2.062E+00 | 1.471E+00 | −6.823E−01 | 0.000E+00 | 0.000E+00 | 0.000E+00 |

In this embodiment, the first lens 11 is made from glass with the refractive index N_{d1} of 1.731 and Abbe's number v_{d1} of 40.5 while the second lens 12 is made from glass with the refractive index N_{d2} of 1.566 and Abbe's number v_{d2} of 24.7. The IR cut-off filter 13 is made from BSC7 (a glass material name).

The fs is 1.1386 mm, f₁ is 1.7332 mm, f₂ is 2.1951 mm, Hₜ is 0.7395 mm, H₊ is 0.5903 mm, TL is 1.527 mm, satisfying from the equation (1) to the equation (5).

$$2 ω = {76}^{°} ; \frac{bf}{TL} = 0.3273 ; \frac{{H}_{+}}{{H}_{t}} = 79.82 \% ; \frac{{d}_{2}}{{f}_{s}} = 0.2359 ; \frac{{f}_{2}}{{f}_{1}} = 1.2665$$

According to the lists and FIG. 4, this embodiment can correct the aberration and can achieve the high resolution, wide angle and compact total length.

### The Second Embodiment

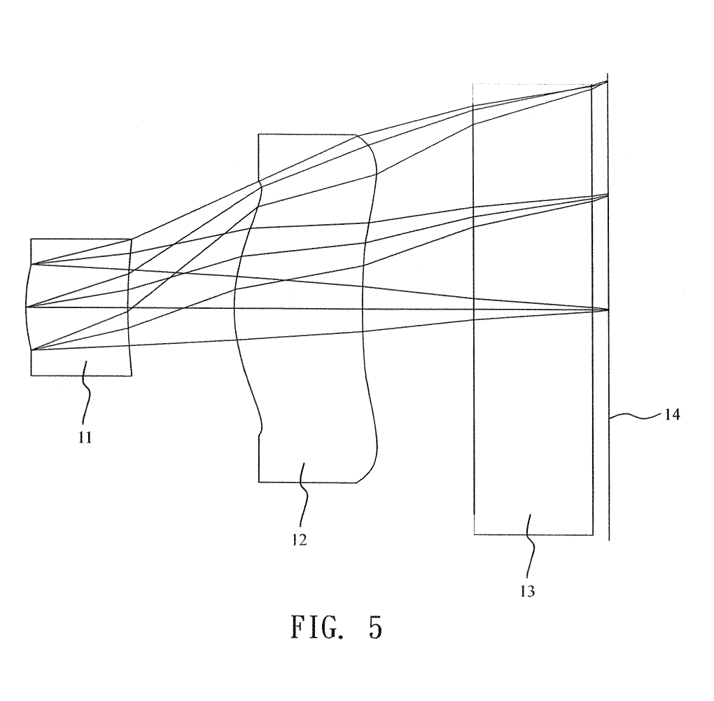

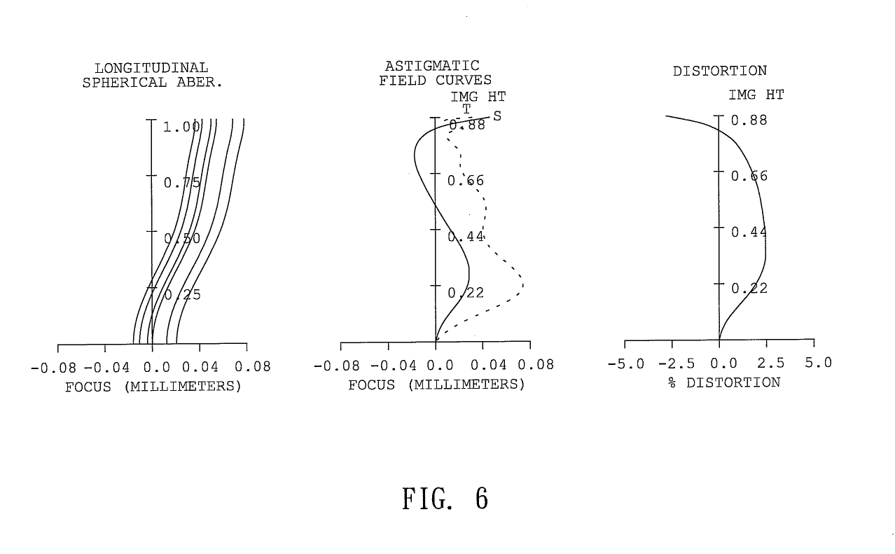

Refer to FIG. 5 & FIG. 6.

List 3
fs = 1.124 Fno = 3.4 2ω = 76.5

| Surface | Lens | R | d | Nd | νd |
|---|---|---|---|---|---|
| Object | | ∞ | | | |
| 1 (Stop) | *R1 | 0.8512 | 0.3000 | 1.566 | 24.7 |
| 2 | *R2 | 2.2348 | 0.3118 | | |
| 3 | *R3 | 0.8483 | 0.3766 | 1.583 | 59.5 |
| 4 | *R4 | 4.5840 | 0.3300 | | |
| 5 | R5 | ∞ | 0.3500 | 1.528 | 62.2 |
| 6 | R6 | ∞ | 0.0499 | | |
| Image | | ∞ | | | |

*aspherical surface

List 4

| | K | A4 | A6 | A8 | A10 | A12 | A14 | A16 |
|---|---|---|---|---|---|---|---|---|
| *R1 | −4.454E+00 | −1.562E+00 | 1.339E+02 | −4.231E+03 | 4.919E+04 | 9.367E+00 | 6.511E+03 | 0.000E+00 |
| *R2 | −1.709E+01 | −7.214E−01 | 9.849E+00 | −2.161E+02 | 2.698E+03 | −1.629E+04 | 2.167E+03 | 0.000E+00 |
| *R3 | −5.392E+01 | 4.712E+00 | −5.443E+01 | 3.543E+02 | −1.117E+03 | −9.591E+02 | 1.673E+04 | −3.418E+04 |
| *R4 | 7.392E+00 | 1.133E+00 | −5.415E+00 | 9.429E+00 | −9.470E+00 | −9.351E+00 | 1.766E+01 | −1.455E+01 |

In this embodiment, the first lens 11 is made from glass with the refractive index N_{d1} of 1.566 and Abbe's number v_{d1} of 24.7 while the second lens 12 is made from glass with the refractive index N_{d2} of 1.583 and Abbe's number v_{d2} of 59.5. The IR cut-off filter 13 is made from BSC7.

The fs is 1.1240 mm, f₁ is 2.2323 mm, f₂ is 1.7104 mm, Hₜ is 0.6620 mm, is 0.5276 mm, TL is 1.718 mm, satisfying from the equation (1) to the equation (5).

$$2 ω = {76.5}^{°} ; \frac{bf}{TL} = 0.4248 ; \frac{{H}_{+}}{{H}_{t}} = 79.69 \% ; \frac{{d}_{2}}{{f}_{s}} = 0.2774 ; \frac{{f}_{2}}{{f}_{1}} = 0.7662$$

According to the lists and FIG. 6, this embodiment of the invention can correct the aberration and can achieve the high resolution, wide angle and compact total length.

### The Third Embodiment

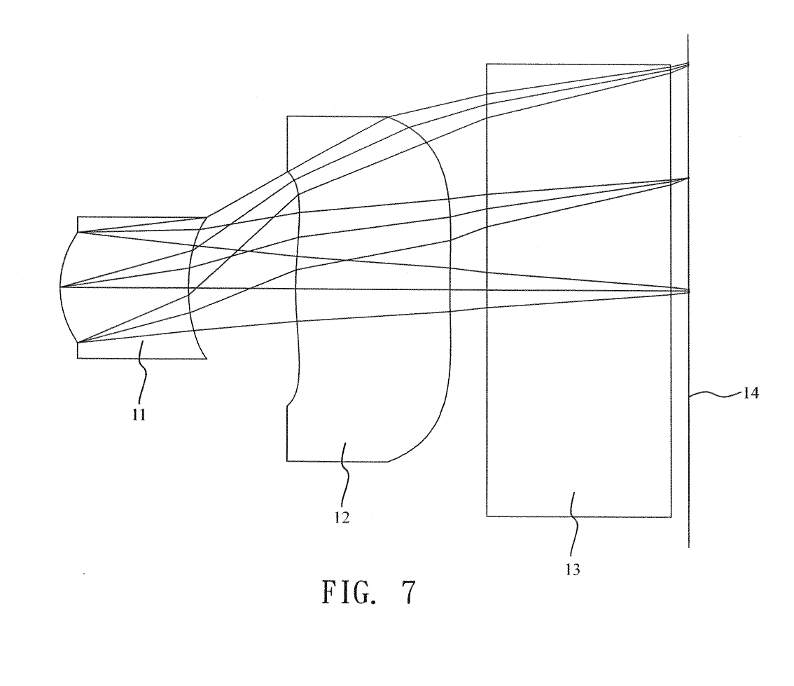

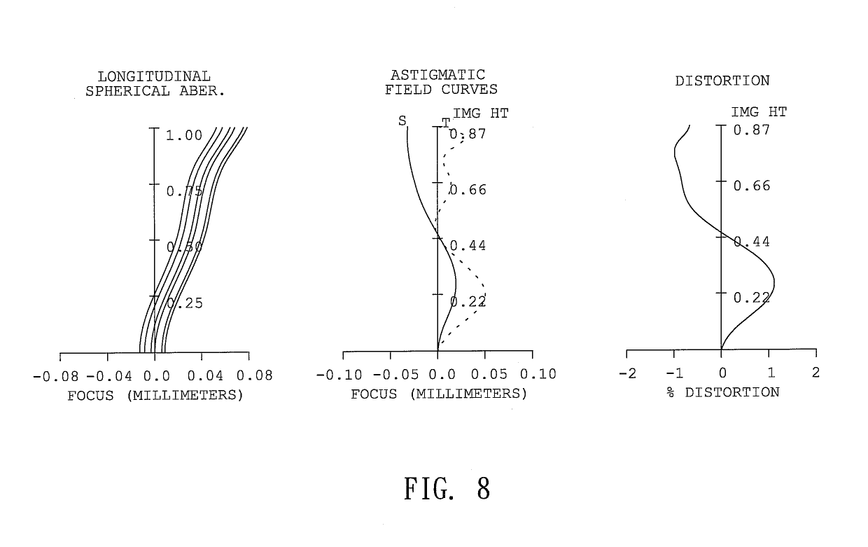

Refer to FIG. 7 & FIG. 8.

List 5
fs = 1.2 Fno = 2.8 2ω = 72

| Surface | Lens | R | d | Nd | νd |
|---|---|---|---|---|---|
| Object | | ∞ | | | |
| 1 (Stop) | *R1 | 0.5141 | 0.3450 | 1.537 | 63.5 |
| 2 | *R2 | 0.9861 | 0.2929 | | |
| 3 | *R3 | 1.7043 | 0.4150 | 1.731 | 40.5 |
| 4 | *R4 | 5.5662 | 0.1000 | | |
| 5 | R5 | ∞ | 0.5000 | 1.528 | 62.2 |
| 6 | R6 | ∞ | 0.0500 | | |
| Image | | ∞ | | | |

*aspherical surface

List 6

| | K | A4 | A6 | A8 | A10 | A12 | A14 | A16 |
|---|---|---|---|---|---|---|---|---|
| *R1 | 2.209E+00 | −2.423E+00 | 5.820E+01 | −1.118E+03 | 5.814E+03 | 1.339E+03 | 1.020E+04 | 1.550E+06 |
| *R2 | 4.108E+00 | −1.054E+00 | 8.267E+01 | −1.292E+03 | 3.145E+03 | 1.440E+05 | −1.261E+06 | 2.120E+06 |
| *R3 | −1.132E+02 | −4.285E−01 | 2.711E+00 | −6.282E+01 | 3.515E+02 | −1.483E+03 | 6.409E+03 | −1.747E+04 |
| *R4 | 2.729E+00 | −1.183E+00 | 2.499E+00 | −5.302E+00 | 9.474E+00 | −7.304E+01 | 2.254E+02 | −2.337E+02 |

In this embodiment, the first lens 11 is made from glass with the refractive index N_{d1} of 1.537 and Abbe's number v_{d1} of 63.5 while the second lens 12 is made from glass with the refractive index N_{d2} of 1.731 and Abbe's number v_{d2} of 40.5. The IR cut-off filter 13 is made from BSC7.

The fs is 1.200 mm, f₁ is 1.5836 f₂ is 3.1876 mm, no inflection point on the surface on the image side R4, TL is 1.7028 mm, satisfying from the equation (1) to the equation (5).

$$2 ω = {72}^{°} ; \frac{bf}{TL} = 0.3817 ; \frac{{d}_{2}}{{f}_{s}} = 0.2440 ; \frac{{f}_{2}}{{f}_{1}} = 2.0128$$

According to the lists and FIG. 8, this embodiment of the invention can correct the aberration and can achieve the high resolution, wide angle and compact total length

### The Fourth Embodiment

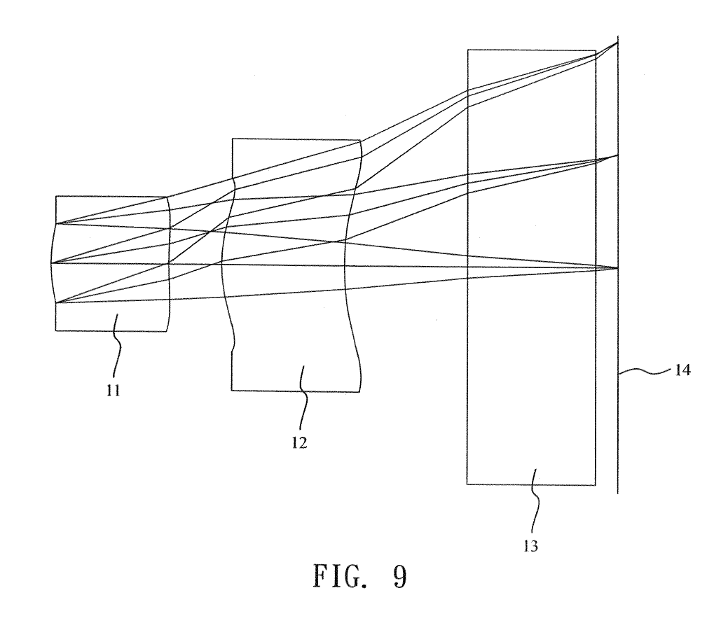

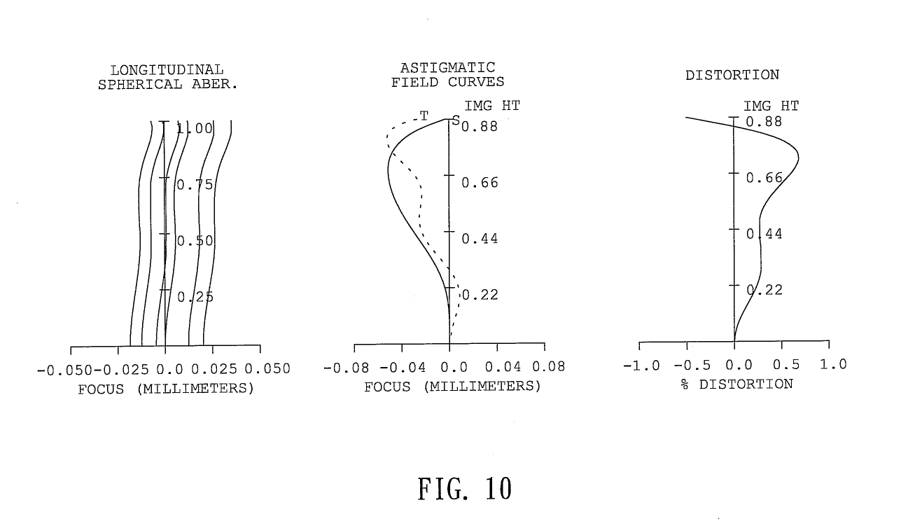

Refer to FIG. 9 & FIG. 10.

List 7
fs = 1.0663 Fno = 3.4 2ω = 80

| Surface | Lens | R | d | Nd | νd |
|---|---|---|---|---|---|
| Object | | ∞ | | | |
| 1 (Stop) | *R1 | 0.8983 | 0.3181 | 1.566 | 24.7 |
| 2 | *R2 | 2.0587 | 0.1430 | | |
| 3 | *R3 | 0.7499 | 0.3365 | 1.731 | 40.51 |
| 4 | *R4 | 1.6731 | 0.3300 | | |
| 5 | R5 | ∞ | 0.3500 | 1.528 | 62.2 |
| 6 | R6 | ∞ | 0.0500 | | |
| Image | | ∞ | | | |

*aspherical surface

List 8

| | K | A4 | A6 | A8 | A10 | A12 | A14 | A16 |
|---|---|---|---|---|---|---|---|---|
| *R1 | −6.461E+00 | −1.737E+00 | 1.371E+02 | −5.785E+03 | 8.375E+04 | 9.368E+00 | 6.511E+03 | 0.000E+00 |
| *R2 | −1.581E+02 | −2.249E+00 | −1.846E+00 | −3.355E+02 | 2.278E+03 | −6.448E+03 | 2.167E+03 | 0.000E+00 |
| *R3 | −3.081E+01 | 3.040E+00 | −5.633E+01 | 3.536E+02 | −1.213E+03 | −2.192E+03 | 5.315E+03 | −1.357E+05 |
| *R4 | 4.770E+00 | 7.374E−01 | −8.811E+00 | 7.289E+00 | −7.195E−01 | 1.576E+01 | 3.477E+01 | −2.658E+02 |

In this embodiment, the first lens 11 is made from glass with the refractive index N_{d1} of 1.566 and Abbe's number v_{d1} of 24.7 while the second lens 12 is made from glass with the refractive index N_{d2} of 1.731 and Abbe's number v_{d2} of 40.5. The IR cut-off filter 13 is made from BSC7 (glass type name).

The fs is 1.0663 mm, f₁ is 2.5387 mm, f₂ is 1.5971 mm, Hₜ is 0.4901 mm, H₊ is 0.4338 mm, TL is 1.527 mm, satisfying from the equation (1) to the equation (5).

$$2 ω = {80}^{°} ; \frac{bf}{TL} = 0.4779 ; \frac{{H}_{+}}{{H}_{t}} = 88.52 \% ; \frac{{d}_{2}}{{f}_{s}} = 0.1341 ; \frac{{f}_{2}}{{f}_{1}} = 0.6291$$

According to the lists and FIG. 10, this embodiment of the invention can correct the aberration and can achieve the high resolution, wide angle and compact total length

### The Fifth Embodiment

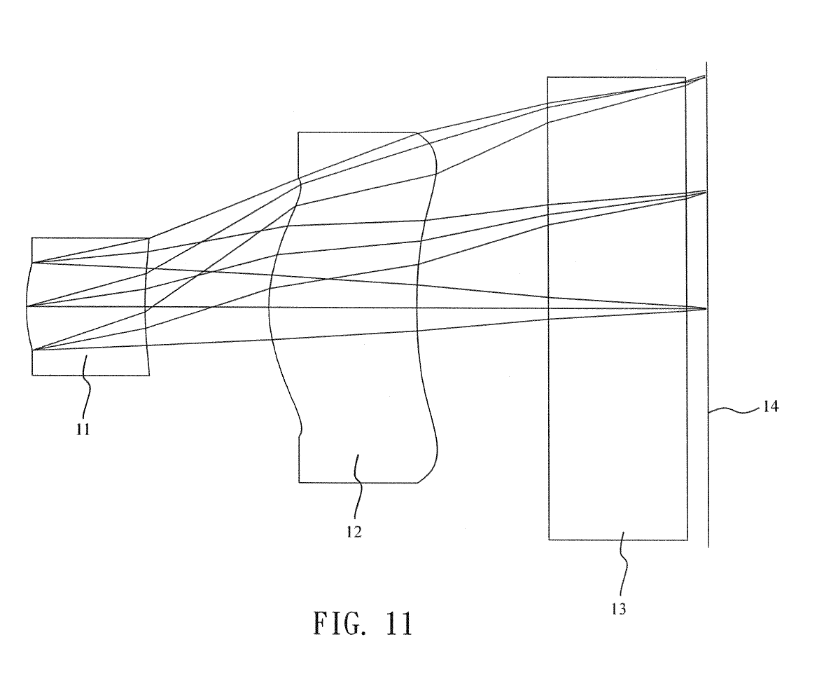

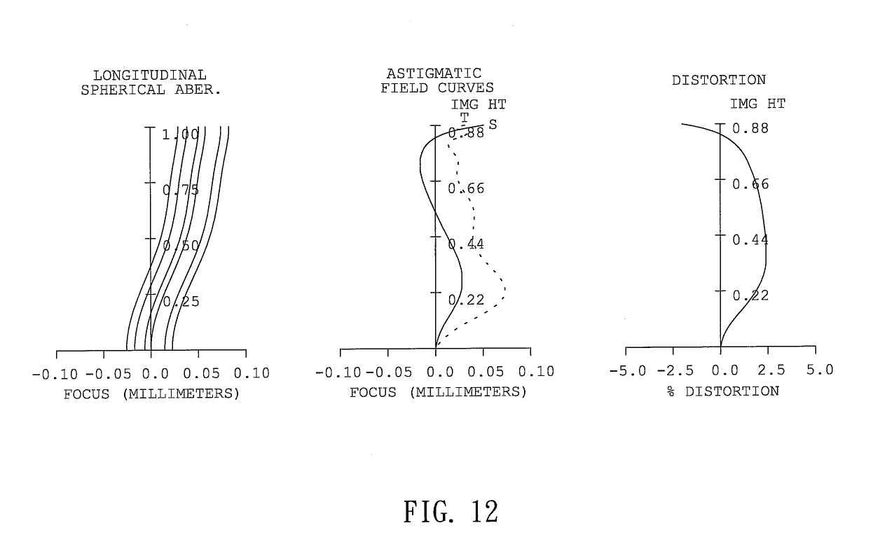

Refer to FIG. 11 & FIG. 12.

List 9
fs = 1.1231 Fno = 3.4 2ω = 76

| Surface | Lens | R | d | Nd | νd |
|---|---|---|---|---|---|
| Object | | ∞ | | | |
| 1 (Stop) | *R1 | 0.8965 | 0.3000 | 1.613 | 26.3 |
| 2 | *R2 | 2.2446 | 0.3129 | | |
| 3 | *R3 | 0.8139 | 0.3724 | 1.566 | 24.7 |
| 4 | *R4 | 4.0851 | 0.3300 | | |
| 5 | R5 | ∞ | 0.3500 | 1.528 | 62.2 |
| 6 | R6 | ∞ | 0.0500 | | |
| Image | | ∞ | | | |

*aspherical surface

List 10

| | K | A4 | A6 | A8 | A10 | A12 | A14 | A16 |
|---|---|---|---|---|---|---|---|---|
| *R1 | −4.842E+00 | −1.640E+00 | 1.353E+02 | −4.248E+03 | 4.925E+04 | 9.369E+00 | 6.511E+03 | 0.000E+00 |
| *R2 | −1.659E+01 | −7.347E−01 | 9.403E+00 | −2.104E+02 | 2.797E+03 | −1.903E+04 | 2.167E+03 | 0.000E+00 |
| *R3 | −5.020E+01 | 4.791E+00 | −5.459E+01 | 3.540E+02 | −1.116E+03 | −9.533E+02 | 1.674E+04 | −3.423E+04 |
| *R4 | 7.284E+00 | 1.164E+00 | −5.424E+00 | 9.207E+00 | −9.442E+00 | −8.957E+00 | 1.773E+01 | −1.599E+01 |

In this embodiment, the first lens 11 is made from glass with the refractive index N_{d1} of 1.613 and Abbe's number v_{d1} of 26.3 while the second lens 12 is made from glass with the refractive index N_{d2} of 1.566 and Abbe's number v_{d2} of 24.7. The IR cut-off filter 13 is made from BSC7.

The fs is 1.1231 mm, f₁ is 2.2367 mm, f₂ is 1.7097 mm, Hₜ is 0.6654 mm, H₊ is 0.5456 mm, TL is 1.715 mm, satisfying from the equation (1) to the equation (5).

$$2 ω = {76}^{°} ; \frac{bf}{TL} = 0.4256 ; \frac{{H}_{+}}{{H}_{t}} = 83.25 \% ; \frac{{d}_{2}}{{f}_{s}} = 0.2786 ; \frac{{f}_{2}}{{f}_{1}} = 0.7644$$

According to the lists and FIG. 12, this embodiment of the invention can correct the aberration and can achieve the high resolution, wide angle and compact total length

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A wide-angle imaging lens system with two positive lenses, along an optical axis from an object side to an image side, comprising:
an aperture stop;
a first lens with positive refractive power that is a biconvex lens with at least one spherical optical surface;
a second lens having positive refractive power that is a meniscus lens with a convex surface on the object side and a concave aspherical surface facing the image side; wherein the following conditions are satisfied:
$$2 ω \geq {70}^{°}$$
$$0.3 \leq \frac{bf}{TL} \leq 0.6$$
wherein bf is back focal length of the imaging lens system, TL is distance from the aperture stop to an image plane, and 2ω is maximum field angle.

2. The device as claimed in claim 1, wherein both concave surfaces of the first lens are aspherical surfaces.

3. The device as claimed in claim 1, wherein both the convex surface and the concave surface of the second lens are aspherical surfaces.

4. The device as claimed in claim 1, wherein the second lens includes at least one inflection point within effective diameter range from a lens center to edge thereof that makes the positive refractive power of the second lens change into negative refractive power and the inflection point satisfies the equation:
$$\frac{{H}_{+}}{{H}_{t}} \geq 75 \%$$
wherein H₊ is perpendicular distance from the inflection point on the image side of the second lens to the optical axis, and Hₜ is perpendicular distance from the maximum optical effective point on the image side of the second lens to the optical axis.

5. The device as claimed in claim 2, wherein the imaging lens system with short focal length and satisfies the equation:
$$0.1 \leq \frac{{d}_{2}}{{f}_{s}} \leq 0.3$$
wherein d₂ is distance from the image side of the first lens to the object side of the second lens, and fₛ is effective focal length of the imaging lens system.

6. The device as claimed in claim 3, wherein the imaging lens system with short focal length and satisfies the equation:
$$0.1 \leq \frac{{d}_{2}}{{f}_{s}} \leq 0.3$$
wherein d₂ is distance from the image side of the first lens to the object side of the second lens, and fₛ is effective focal length of the imaging lens system.

7. The device as claimed in claim 2, wherein the imaging lens system satisfies the equation:
$$0.5 \leq \frac{{f}_{2}}{{f}_{1}} \leq 2.2$$
wherein f₁ is focal length of the first lens, and f₂ is effective focal length of the second lens.

8. The device as claimed in claim 3, wherein the imaging lens system satisfies the equation:
$$0.5 \leq \frac{{f}_{2}}{{f}_{1}} \leq 2.2$$
wherein f₁ is focal length of the first lens, and f₂ is effective focal length of the second lens.

9. The device as claimed in claim 1, wherein both the first lens and the second lens are made from glass.

10. The device as claimed in claim 1, wherein the first lens is made from glass and the second lens is made from plastic.

11. The device as claimed in claim 1, wherein the first lens is made from plastic and the second lens is made from glass.
